(19) United States
(12) Patent Application Publication
(10) Pub. No.: US 2026/0171866 A1
(43) Pub. Date: Jun. 18, 2026

(54) DRIVE UNIT HOUSING WITH INTEGRATED FILTER

(71) Applicant: GM Global Technology Operations LLC, Detroit, MI (US)

(72) Inventors: Renato Amorim Torres, Pontiac, MI (US); Ronald O. Grover, JR., Northville, MI (US); Chandra S. Namuduri, Troy, MI (US); Suresh Gopalakrishnan, Troy, MI (US); Yilun Luo, Ann Arbor, MI (US)

(73) Assignee: GM Global Technology Operations LLC, Detroit, MI (US)

(21) Appl. No.: 18/985,539

(22) Filed: Dec. 18, 2024

(51) Int. Cl. H02K 5/22; H02K 9/00; H02K 11/00

(52) U.S. Cl. CPC H02K 5/225; H02K 9/00; H02K 11/0094; H02K 2203/03

(57) ABSTRACT

A drive unit assembly includes a motor having a motor housing, a shaft extending through the motor housing, a rotor coupled to the shaft, a stator arranged about the rotor, and one or more motor bus bars communicatively coupled to the stator. The drive unit assembly further includes a filter having a filter housing coupled to the motor housing, one or more filter bus bars each having an inlet and an outlet configured to be communicatively coupled to at least one of the one or more motor bus bars, a printed circuit board (PCB) communicatively coupled to the one or more filter bus bars, and one or more dissipative components coupled to the PCB.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to vehicles and, more particularly, to a voltage filter for a drive unit of a vehicle.

Electric vehicles (EVs) and hybrid electric vehicles (HEVs) rely on drive units, or motors, to convert electrical energy into mechanical energy for propulsion. Performance of these drive units is critical for the overall efficiency and reliability of the vehicle. Alternating current (AC) filters can be used to mitigate electrical noise and harmonics that can interfere with motor performance. By filtering out unwanted frequencies, alternating current (AC) filters help maintain the integrity of electrical signals, ensuring smoother and more reliable motor operation.

A key factor affecting AC filter performance is the length of the leads connecting the filter to the drive unit. Longer leads can result in more common mode current, leading to increased electromagnetic interference (EMI) and core heating in the motor. Shortcomings of existing systems will be addressed by one or more principles of the present disclosure.

### SUMMARY

In one configuration, a drive unit assembly is provided and includes a motor having a motor housing, a shaft extending through the motor housing, a rotor coupled to the shaft, a stator arranged about the rotor, and one or more motor bus bars communicatively coupled to the stator. The drive unit assembly further includes a filter having a filter housing coupled to the motor housing, one or more filter bus bars each having an inlet and an outlet configured to be communicatively coupled to at least one of the one or more motor bus bars, a printed circuit board (PCB) communicatively coupled to the one or more filter bus bars, and one or more dissipative components coupled to the PCB.

The drive unit assembly may include one or more of the following optional aspects or steps. For example, the filter housing can be coupled to the motor housing with one or more bolts.

According to at least one aspect, the filter can include a thermal interface material (TIM) disposed between the one or more dissipative components and the motor housing.

According to another aspect, the filter can include a TIM disposed between the PCB and the motor housing.

According to at least one example, the drive unit assembly can further include a cooling system communicatively coupled with the motor housing. The cooling system can include one or more conduits communicatively coupled with the one or more dissipative components. A TIM can be disposed between the one or more conduits and the dissipative components.

According to at least one aspect, the drive unit assembly can further include filter bus bars communicatively coupled to the PCB. The PCB can be coupled to the filter bus bars with one or more fasteners. One or more conductive lugs can be disposed between the bus bars and the PCB with respect to the one or more fasteners.

In another configuration, a drive unit assembly is provided and includes a motor including a motor housing defining a chamber, a shaft extending through the motor housing, a rotor coupled to the shaft, a stator arranged about the rotor, a fluid movable throughout the chamber, and one or more motor bus bars communicatively coupled to the stator. The drive unit assembly further includes a filter disposed within the chamber of the motor housing and one or more dissipative components coupled to the filter.

The drive unit assembly may include one or more of the following optional aspects or steps. For example, the one or more dissipative components may be arranged within the chamber and coupled directly to the filter.

According to at least one aspect, the one or more dissipative components can be arranged outside of the motor housing and communicatively coupled with the filter.

According to another aspect, the filter can be arranged within the motor housing and the fluid directly contacts or submerges the filter.

According to at least one example, the filter can be enclosed in a case. The case can be mounted to the motor housing with one or more fasteners.

In another configuration, a vehicle is provided and includes a vehicle body, an inverter coupled to the vehicle body, a power source coupled to the vehicle body and communicatively coupled to the inverter, and a drive unit assembly communicatively coupled to the inverter with an alternating current (AC) cable. The drive unit assembly including a motor having a motor housing, a fluid movable throughout the motor housing, a shaft extending through the motor housing, a rotor coupled to the shaft, and a stator arranged about the rotor. The drive unit assembly further includes a filter communicatively coupled to the motor including one or more bus bars each having an inlet and an outlet and a printed circuit board (PCB) communicatively coupled to the one or more bus bars. The drive unit assembly further includes one or more dissipative components communicatively coupled to the filter.

The vehicle may include one or more of the following optional aspects or steps. For example, the filter may be arranged inside of the motor housing and the one or more dissipative components may be arranged outside of the motor housing.

According to at least one aspect, the filter may be disposed inside of the motor housing. The filter can be arranged in a case that is coupled to the motor housing.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle including a propulsion system according to principles of the present disclosure;

FIG. 2 is a schematic view of a circuit diagram of a portion of the propulsion system of FIG. 1 according to the principles of the present disclosure;

FIG. 3 is cross-sectional view of a configuration of a drive unit assembly according to the principles of the present disclosure;

FIG. 4 is cross-sectional view of another configuration of a drive unit assembly according to the principles of the present disclosure;

FIG. 5A is a cross-sectional view of a configuration of a printed circuit board (PCB) and bus bar according to the principles of the present disclosure;

FIG. 5B is an end view of a conductive lug disposed between the PCB and bus bar of FIG. 5A;

FIG. 6 is a fragmentary side view of a configuration of a filter arranged on a motor housing according to principles of the present disclosure;

FIG. 7 is cross-sectional view of another configuration of a drive unit assembly according to the principles of the present disclosure;

FIG. 8 is cross-sectional view of another configuration of a drive unit assembly according to the principles of the present disclosure;

FIG. 9 is cross-sectional view of another configuration of a drive unit assembly according to the principles of the present disclosure; and

FIG. 10 is cross-sectional view of another configuration of a drive unit assembly according to the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

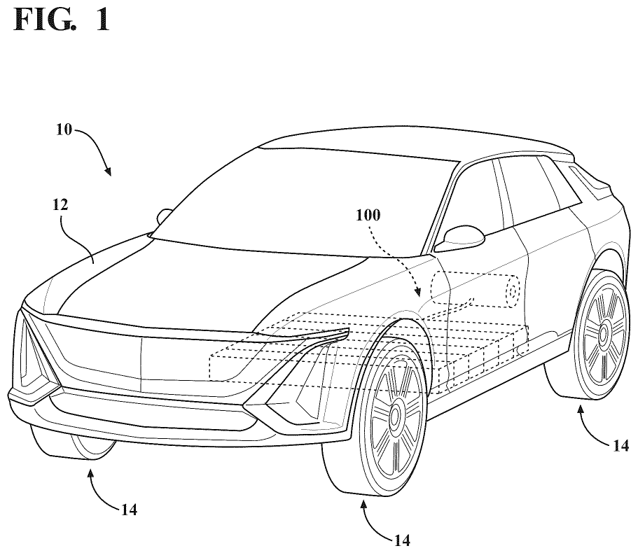

With reference to FIG. 1, an illustrative example of a vehicle 10 having a vehicle body 12 is provided. The vehicle 10 includes one or more wheels 14 coupled to the vehicle body 12. Additionally, the vehicle 10 includes a propulsion system 100 for providing power to at least one of the one or more wheels 14 to propel the vehicle 10.

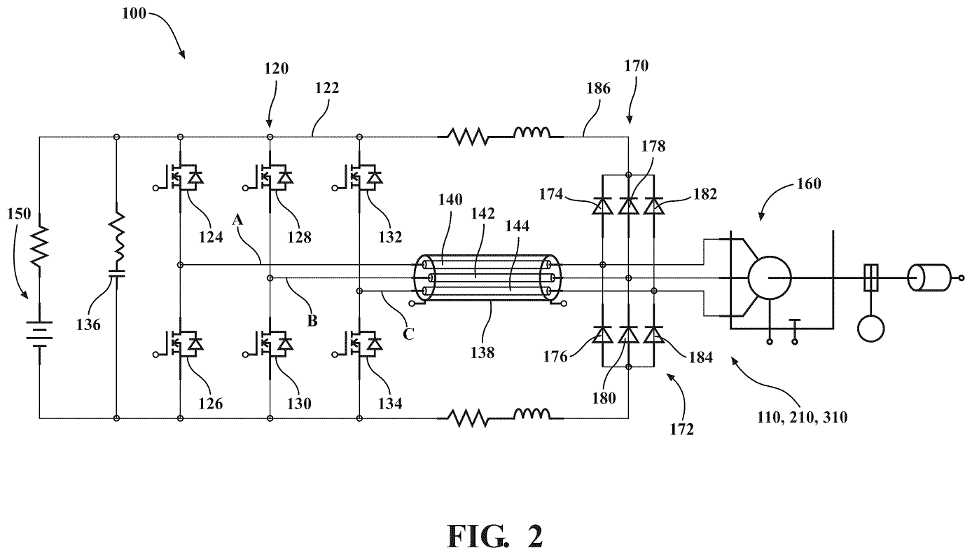

In general, with reference to FIG. 2, the propulsion system 100 includes a drive unit assembly 110, an inverter 120, and a power source (e.g., a battery) 150. The drive unit assembly 110 can include a motor 160 and a current a filter 170 communicatively coupled to the motor 160.

The motor 160 can be a three-phase alternating current (AC) motor receiving three-phase AC power (although configurations described herein can be used with motors or machines having any number of phases).

The inverter 120 includes various switching devices connected to a propulsion bus 122. For example, a first switching assembly includes an inverter switch 124 and an inverter switch 126 connected to a first phase (phase A) of the motor 160, a second switching assembly includes an inverter switch 128 and an inverter switch 130 connected to a second phase (phase B), and a third switching assembly includes an inverter switch 132 and an inverter switch 134 connected to a third phase (phase C). Additional components may be included, such as a capacitor 136 for ripple current and voltage stabilization.

In at least one configuration, each inverter switch is a semiconductor switch. As non-limiting examples, inverter switches may include metal-oxide-semiconductor (MOS)-controlled Thyristors (MCTs), gallium-nitride (GaN) field-effect transistors (FETs), metal-oxide-semiconductor field-effect transistors (MOSFETs), silicon carbide junction field-effect transistors (SiC JFETs), insulated-gate bipolar transistors (IGBTs) or any other suitable low loss device of suitable voltage and current ratings.

Each switching assembly can be a half-bridge connected to a phase of the AC cable 138. For example, the switches 124 and 126 form a half-bridge that is connected to a phase A conductor 140 of the AC cable 138, and the switches 128 and 130 form a half-bridge connected to a phase B conductor 142. The switches 132 and 134 form a half-bridge connected to a phase C conductor 144.

The phase A conductor 140 is connected to a phase A winding of the motor 160, the phase B conductor 142 is connected to a phase B winding, and the phase C conductor 144 is connected to a phase C winding.

The filter 170 can include a diode bridge rectifier circuit 172. The diode bridge rectifier circuit 172 includes a pair of diodes in a half-bridge configuration connected to each phase of the motor 160 and the AC cable 138. Each half-bridge has an input connected to a motor phase (an AC input), and a direct current (DC) output for dissipating energy or transmitting energy away from the motor 160.

For example, the diode bridge rectifier circuit 172 (which is also referred to as a diode bridge circuit 172) includes a pair of diodes 174, 176, which are connected in parallel to the conductor 140 and/or the phase A terminal. A pair of diodes 178, 180 are connected in parallel to the conductor 142 and/or the phase B terminal, and a pair of diodes 182, 184 are connected in parallel to the conductor 144 and/or the phase C terminal.

According to at least one aspect, the DC output of the diode bridge circuit 172 is connected to the propulsion bus 122 by a low inductance cable 186. The low inductance cable 186 is configured for transmitting DC power output from the diode bridge circuit 172. The low inductance cable 186 can be used to return or route DC energy from voltage spikes to the inverter 120 and the power source 150. Routing energy back to the inverter 120 and the power source 150 can increase the effectiveness of the diode bridge circuit 172 in mitigating overvoltages with minimal power loss.

For the purposes of the present disclosure, a “low inductance” cable can be any conductor or set of conductors that exhibits an inductance below a selected threshold. According to one aspect, each phase of the low inductance cable (e.g., a three-phase coaxial cable) has an inductance of less than about 1 microhenry (μH), and/or an inductance that is less than about 1/10th the inductance of the AC cable 138. For example, a twisted pair or coaxial cable having a small gauge (e.g., an American wire gauge (AWG) of 10 or 12) may be used as the low inductance cable.

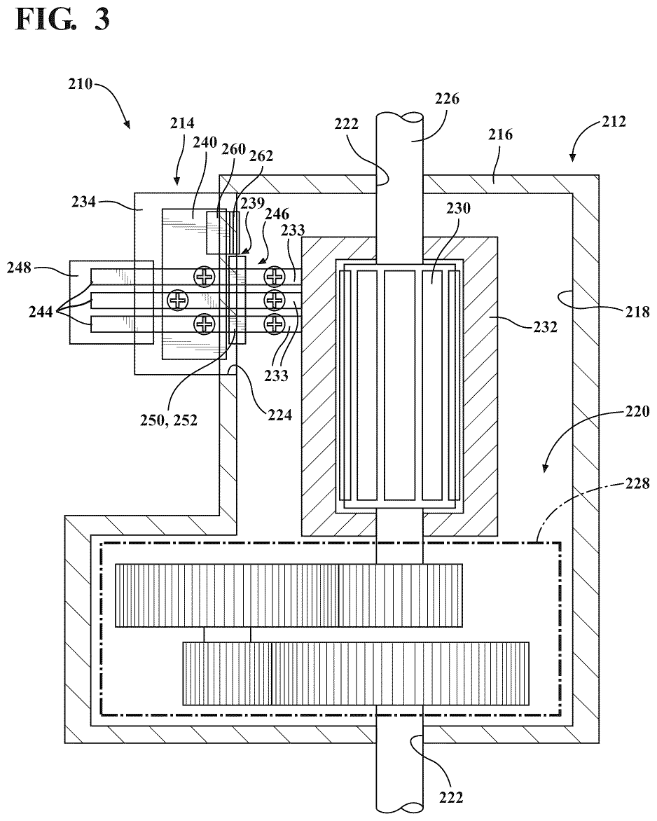

FIGS. 3-7 illustrate another illustrative configuration of a drive unit assembly 210. This configuration is similar in many respects to the configuration of FIGS. 1-2. Accordingly, the descriptions of the configurations are hereby incorporated into one another, and description of subject matter common to the configurations generally may not be repeated.

With reference to FIG. 3, the drive unit assembly 210 is provided and includes a motor (i.e., drive unit) 212 and a filter 214. The motor 212 includes a motor housing 216 that encases and protects the internal components of the motor 212. The motor housing 216 can be made of one or more materials including cast iron or aluminum, for example. The motor housing 216 also defines a chamber 218 that contains a fluid 220, such as a lubricant (e.g., lubricating oil) or a coolant. The fluid 220 can contact one or more moving parts, such as bearings, gears, etc., to reduce friction and wear and to remove heat from components. The motor housing 216 can include one or more shaft openings 222 and one or more electrical openings 224. The motor 212 also includes a shaft 226 extending between the one or more shaft openings 222 and through the motor housing 216. A gear box 228 can be communicatively coupled to the shaft 226 and can move (e.g., agitate) the fluid 220 through the chamber 218. A rotor 230 can be coupled to the shaft 226 and a stator 232 can be arranged about the rotor 230. One or more motor bus bars 233 configured for single-phase, three-phase, or n-phase electrical power can be communicatively coupled to the stator 232 and can be arranged in or adjacent to the one or more electrical openings 224.

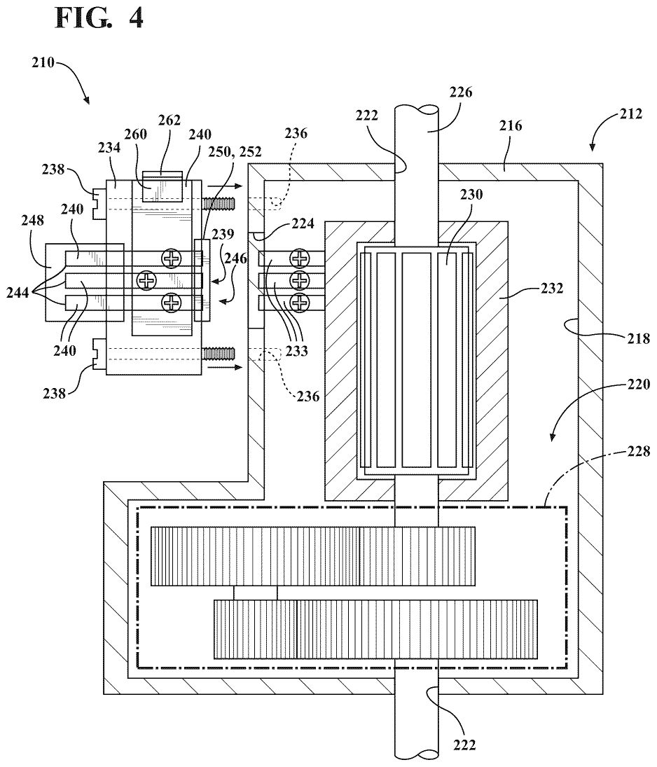

In the present illustrative configuration, the drive unit assembly 210 includes a filter housing 234 that can be configured to be attached or otherwise coupled to the motor housing 216. For instance, as shown in FIG. 3, the filter housing 234 can be welded (e.g., laser, TIG, etc.), glued (e.g., via adhesive), or otherwise coupled to the motor housing 216 via another method commonly used in the automotive industry. According to one aspect, with reference to FIG. 4, the motor housing 216 can include or more threaded openings 236 that are configured to receive one or more bolts 238 so that the filter housing 234 can be secured to or otherwise fastened to the motor housing 216. The filter housing 234 can include one or more connector openings 239 and at least one of which can be configured to communicate with at least one of the electrical openings 224 of the motor housing 216. Additionally, the filter housing 234 can be configured to encase and protect the filter 214.

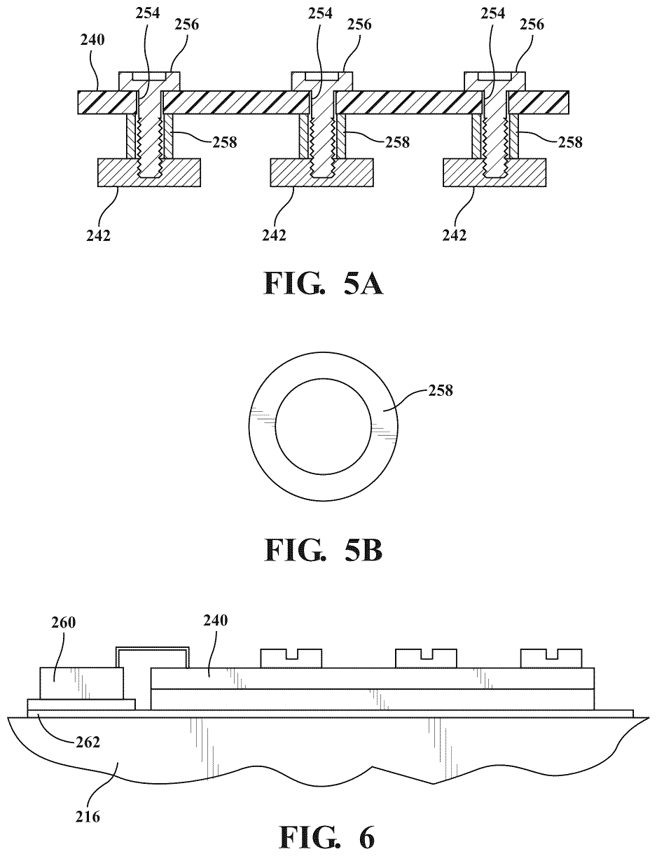

The filter 214 can be configured as an alternating current (AC) filter, such as a passive low pass filter (i.e., a passive resistor-capacitor (RC) filter), a resistor-capacitor-diode filter (RCD), or an active RCD filter, for example. For the active RCD filter, a resistor can be partially or fully replaced by a semiconductor device such as a MOSFET or IGBT. In any case, the filter 214 can be configured to be coupled in parallel to the motor 212. According to one aspect, the filter 214 can include a printed circuit board (PCB) 240 communicatively coupled to one or more filter bus bars 242 (FIG. 5A) that have one or more first or inlet terminals 244 and one or more second or outlet terminals 246. A first connector 248 can be coupled to the inlet terminals 244 so that the filter 214 can be easily coupled to an inverter or another electrical component. Likewise, a second connector 250 can be coupled to the one or more outlet terminals 246 so that the filter 214 can be easily coupled to the motor 212 (i.e., the one or more motor bus bars 233). Additionally, a seal 252 can be coupled adjacent to the one or more outlet terminals 246 that is configured to seal the one or more electrical openings 224 of the motor housing 216 and prevent the fluid 220 from escaping or leaking from the chamber 218.

With reference to FIG. 5A, the PCB 240 can include one or more through holes 254 that are configured to receive one or more fasteners 256. With reference to FIGS. 5A and 5B, one or more conductive lugs or spacers 258 can be arranged between and communicatively couple the PCB 240 and the one or more filter bus bars 242.

In general, the PCB 240 can be configured with field cancelling properties to minimize loop leakage inductance across the terminals 244, 246 of the filter 214. The filter 214 can include one or more dissipative components 260 (e.g., power resistors, active power devices (e.g., metal oxide semiconductor field-effect transistor (MOSFET), insulated-gate bipolar transistor (IGBT)), etc.). According to one aspect, the one or more dissipative components 260 can be coupled to the PCB 240 directly or indirectly. Additionally, a phase change thermal interface material (TIM) 262, as shown in FIG. 3, can be arranged between the one or more dissipative components 260 and the motor housing 216. Additionally or alternatively, with reference to FIG. 6, the TIM 262 can be arranged between the PCB 240 and the motor housing 216. These arrangements can be desirable for utilizing the motor housing 216 as a heat sink for removing heat from the filter 214 and/or the one or more dissipative components 260. According to another aspect, the filter 214 can be encapsulated with thermally conductive and electrically insulating encapsulant, which can be desirable for improving thermal performance and mechanical strength, for example.

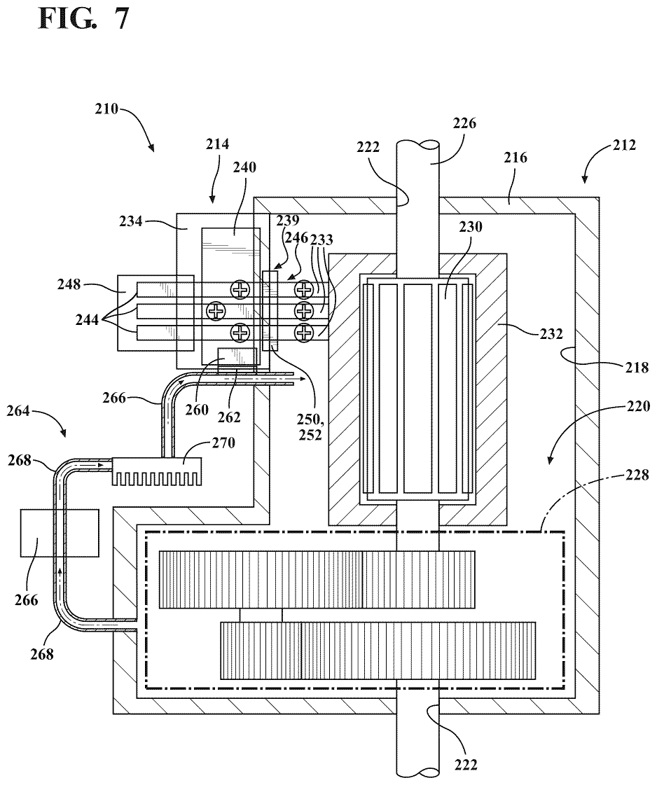

With reference to FIG. 7, the drive unit assembly 210 can include a cooling system 264 that is communicatively coupled to the chamber 218 of the motor housing 216. The cooling system 264 can include a pump 266 that is configured to move the fluid 220 along one or more conduits 268 to a heat exchanger 270 to remove heat from the fluid 220. Additionally, the cooling system 264 can be configured so that one or more of the conduits 268 is communicatively coupled to the one or more dissipative components 260. More particularly, the TIM 262 can be arranged between one of the conduits 268 and the one or more dissipative components 260 and/or the PCB 240 so that heat can be removed during and/or after operation of the drive unit assembly 210, for example.

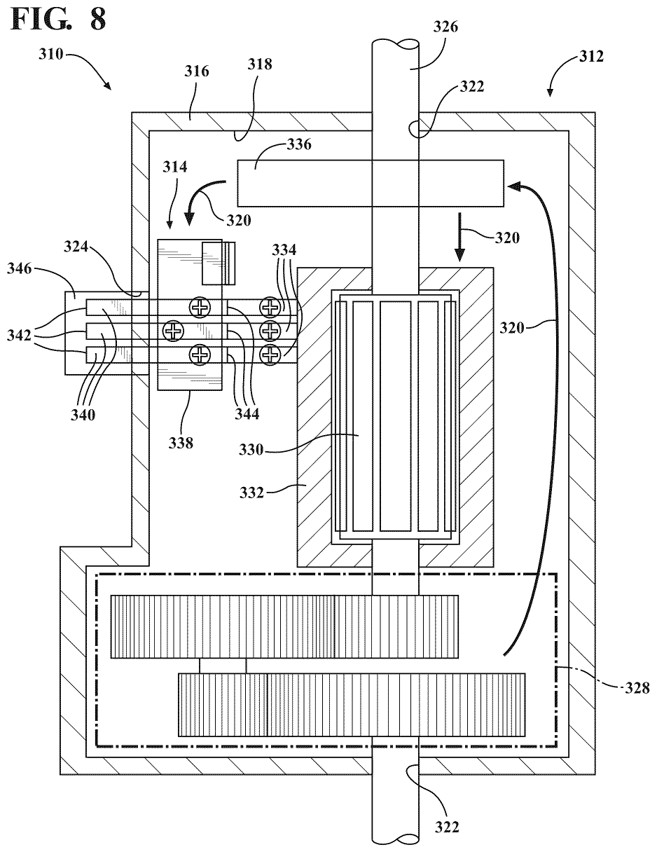

FIG. 8 illustrates another illustrative configuration of a drive unit assembly 310. This configuration is similar in many respects to the configuration of FIGS. 1-2 and FIGS. 3-7. Accordingly, the descriptions of the configurations are hereby incorporated into one another, and description of subject matter common to the configurations generally may not be repeated.

With reference to FIG. 8, the drive unit assembly 310 is provided and includes a motor 312 and a filter 314. The motor 312 includes a motor housing 316 that encases and protects the internal components of the motor 312 and/or at least a portion of the filter 314. The motor housing 316 can be made of one or more materials including cast iron or aluminum, for example. The motor housing 316 also defines a chamber 318 that contains a fluid 320 (e.g., lubricating oil). The fluid 320 can contact one or more moving parts, such as bearings, gears, etc., to reduce friction and wear. Additionally or alternatively, the fluid 320 can contact the filter 314 and remove heat during or after operation, for example. The motor housing 316 can include one or more shaft openings 322 and one or more electrical openings 324. The motor 312 also includes a shaft 326 extending through the motor housing 316 at least between the one or more shaft openings 322. A gear box 328 can be communicatively coupled to the shaft 326 and can be configured to circulate (e.g., splash) the fluid 320 throughout the chamber 318. A rotor 330 can be coupled to the shaft 326 and a stator 332 can be arranged about the rotor 330. One or more motor bus bars 334 configured for single-phase, three-phase, or n-phase electrical power can be communicatively coupled to the stator 332 and can be arranged in or adjacent to the one or more electrical openings 224.

With continued reference to FIG. 8, the drive unit assembly 310 can include a fluid reservoir 336 for cooling one or more components within the motor housing 316. According to one aspect, the fluid reservoir can be configured to rely on gravity for controlled release of the fluid 320 (i.e., gravity feeding). In another configuration, the fluid 320 can be sprayed continuously or selectively spayed on components arranged within the motor housing 316.

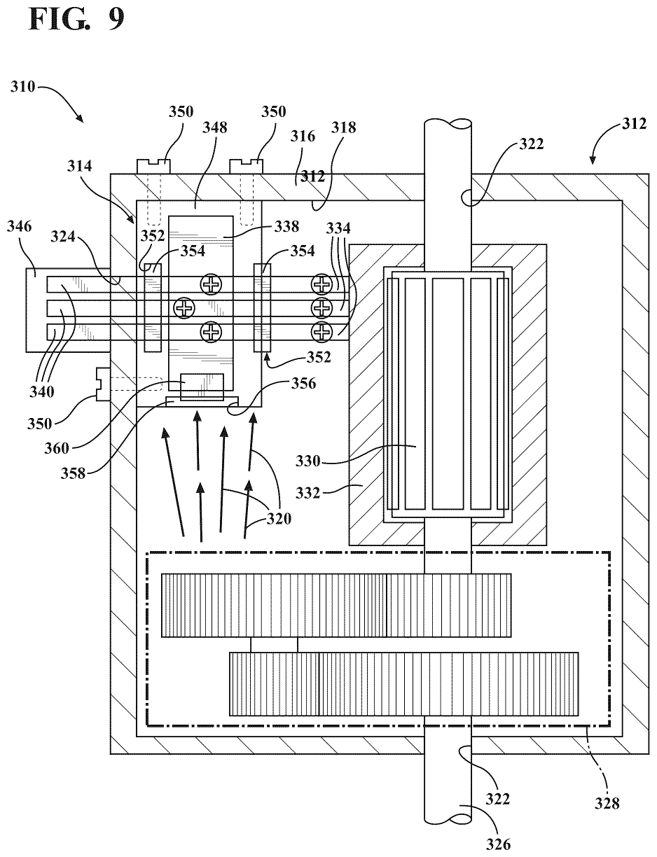

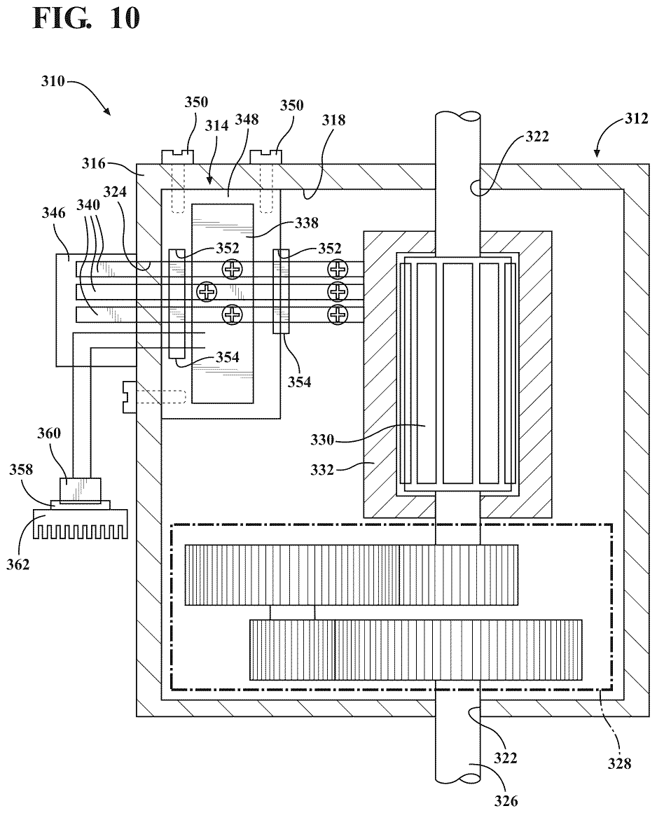

In the present illustrative configuration, the filter 314 is arranged within the chamber 318 of the motor housing 316 and can be directly (FIG. 8) or indirectly (FIGS. 9 and 10) coupled to the motor housing 316. The filter 314 can be configured as an alternating current (AC) filter, such as a passive low pass filter (i.e., a passive resistor-capacitor (RC) filter), a resistor-capacitor-diode filter (RCD), or an active RCD filter, for example. In any case, the filter 314 can be configured to be coupled in parallel to the motor 312.

According to one aspect, the filter 314 can include a printed circuit board (PCB) 338 communicatively coupled to one or more filter bus bars 340 that have one or more first or inlet terminals 342 and one or more second or outlet terminals 344. A first connector 346 can be coupled to the inlet terminals 342 so that the filter 314 can be easily coupled to an inverter or another electrical component. The one or more outlet terminals 344 can be configured to be communicatively coupled to the one or more motor bus bars 334 via a connector or otherwise.

The filter 314 can include components that are configured to directly contact the fluid 320 in the chamber 318. In other words, the components of the filter 314 can be configured to withstand high temperatures and corrosive environments, for example. This may be desirable for thermal management of the filter 314, for example. Alternatively, at least a portion of the filter 314 can be encapsulated with thermally conductive and electrically insulating encapsulant. Encapsulating at least a portion of the filter 314 can be desirable for improving thermal performance and mechanical strength, for example.

In at least some configurations (FIGS. 9 and 10), the filter 314 can be enclosed in a case 348 and arranged within the motor housing 316. In the present illustrative examples, with reference to FIGS. 9 and 10, the case 348 can be mounted within the chamber 318 with one or more clips or fasteners 350. The case 348 can include one or more electrical openings 352 and one or more seals 354 that are configured to receive the one or more filter bus bars 340 but prevent the fluid 320 from entering or leaking into the case 348. According to at least one aspect, the PCB 338 can include one or more thermal pathways 356 that are configured to receive a phase change thermal interface material (TIM) 358.

The filter 314 can include one or more dissipative components 360 directly (FIGS. 8 and 9) or indirectly (FIG. 10) coupled to the PCB 338. With reference to FIG. 10, the one or more dissipative components 360 are communicatively coupled to the PCB 338 and arranged outside of the motor housing 316. According to one aspect, the dissipative component 360 can be coupled to an exterior heat sink 362 to remove heat from the filter 314, for example.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A drive unit assembly, comprising:
a motor, comprising:
a motor housing,
a shaft extending through the motor housing,
a rotor coupled to the shaft,
a stator arranged about the rotor, and
one or more motor bus bars communicatively coupled to the stator; and
a filter, comprising:
a filter housing coupled to the motor housing,
one or more filter bus bars each having an inlet and an outlet configured to be communicatively coupled to at least one of the one or more motor bus bars,
a printed circuit board (PCB) communicatively coupled to the one or more filter bus bars, and
one or more dissipative components coupled to the PCB.

2. The drive unit assembly of claim 1, wherein the filter housing is coupled to the motor housing with one or more bolts.

3. The drive unit assembly of claim 1, wherein the filter includes a thermal interface material (TIM) disposed between the one or more dissipative components and the motor housing.

4. The drive unit assembly of claim 1, wherein the filter includes a TIM disposed between the PCB and the motor housing.

5. The drive unit assembly of claim 1, wherein the drive unit assembly further includes a cooling system communicatively coupled with the motor housing.

6. The drive unit assembly of claim 5, wherein the cooling system includes one or more conduits communicatively coupled with the one or more dissipative components.

7. The drive unit assembly of claim 6, wherein a TIM is disposed between the one or more conduits and the dissipative components.

8. The drive unit assembly of claim 1, wherein the drive unit assembly further includes filter bus bars communicatively coupled to the PCB.

9. The drive unit assembly of claim 8, wherein the PCB is coupled to the filter bus bars with one or more fasteners.

10. The drive unit assembly of claim 9, wherein one or more conductive lugs are disposed between the bus bars and PCB with respect to the one or more fasteners.

11. A drive unit assembly, comprising:
a motor, comprising:
a motor housing defining a chamber,
a shaft extending through the motor housing,
a rotor coupled to the shaft,
a stator arranged about the rotor,
a fluid movable throughout the chamber, and
one or more motor bus bars communicatively coupled to the stator;
a filter disposed within the chamber of the motor housing; and
one or more dissipative components coupled to the filter.

12. The drive unit assembly of claim 11, wherein the one or more dissipative components are arranged within the chamber and coupled directly to the filter.

13. The drive unit assembly of claim 11, wherein the one or more dissipative components are arranged outside of the motor housing and communicatively coupled with the filter.

14. The drive unit assembly of claim 11, wherein the filter is arranged within the motor housing and the fluid directly contacts or submerges the filter.

15. The drive unit assembly of claim 11, wherein the filter is enclosed in a case.

16. The drive unit assembly of claim 15, wherein the case is mounted to the motor housing with one or more fasteners.

17. A vehicle, comprising:
a vehicle body;
an inverter coupled to the vehicle body;
a power source coupled to the vehicle body and communicatively coupled to the inverter;
a drive unit assembly communicatively coupled to the inverter with an alternating current (AC) cable, the drive unit assembly comprising:
a motor, comprising:
a motor housing,
a fluid movable throughout the motor housing,
a shaft extending through the motor housing,
a rotor coupled to the shaft, and
a stator arranged about the rotor;
a filter communicatively coupled to the motor, the filter comprising:
one or more bus bars each having an inlet and an outlet, and
a printed circuit board (PCB) communicatively coupled to the one or more bus bars; and
one or more dissipative components communicatively coupled to the filter.

18. The vehicle of claim 17, wherein the filter is arranged inside of the motor housing and the one or more dissipative components is arranged outside of the motor housing.

19. The vehicle of claim 17, wherein the filter is disposed inside of the motor housing.

20. The vehicle of claim 19, wherein the filter is arranged in a case that is coupled to the motor housing.
